(19) United States
(12) Patent Application Publication
(10) Pub. No.: US 2013/0260166 A1
(43) Pub. Date: Oct. 3, 2013

(54) Coated Titanium Alloy Surfaces

(71) Applicant: KENNAMETAL INC., Latrobe, PA (US)

(72) Inventors: Paul Dehnhardt Prichard, Greensburg, PA (US); Joel Thomas Dawson, Irwin, PA (US); Mark Rowe, New Derry, PA (US)

(73) Assignee: Kennametal Inc., Latrobe, PA (US)

(21) Appl. No.: 13/852,440

(22) Filed: Mar. 28, 2013

Related U.S. Application Data
(63) Continuation-in-part of application No. 13/437,301, filed on Apr. 2, 2012.

(51) Int. Cl. B32B 15/04; B05D 3/02; B32B 15/16

(52) U.S. Cl. CPC B32B 15/043; B32B 15/16; B05D 3/0254
USPC 428/564; 428/661; 428/553; 427/384

(57) ABSTRACT

In one aspect, composite articles are described herein comprising a lightweight, high strength metal substrate and an abrasion resistant coating adhered to the substrate. In some embodiments, a composite article described herein comprises a titanium or titanium alloy substrate and a coating adhered to the substrate, the coating comprising particles disposed in a metal or alloy matrix.

### RELATED APPLICATION DATA

The present application is a continuation-in-part of U.S. patent application Ser. No. 13/437,301 filed Apr. 2, 2012 which is incorporated herein by reference in its entirety.

### FIELD

The present invention relates to coatings for metallic substrates and, in particular, to coatings for titanium and titanium alloy substrates.

### BACKGROUND

Coatings are often applied to equipment subjected to demanding environments or operating conditions in efforts to extend the useful lifetime of the equipment. Various coating constructions are available depending on substrate identity and the mode of failure to be inhibited. For example, wear resistant, erosion resistant and corrosion resistant claddings have been developed for heavy and durable substrates of cast iron, low-carbon steels, alloy steels and tool steels. However, given divergent metal chemistries, cladding technologies proven effective for steels are generally unsuitable for lightweight metal systems leading to undesirable cladding properties and premature cladding failure by a variety of mechanisms.

### SUMMARY

In one aspect, composite articles are described herein comprising a lightweight, high strength metal substrate and a wear resistant coating adhered to the substrate. In some embodiments, a composite article comprises a titanium or titanium alloy substrate and a coating adhered to the substrate, the coating comprising particles disposed in a metal or alloy matrix, wherein the coating has an adjusted volume loss of less than 20 mm³ determined according to Procedure E of ASTM G65—Standard Test Method for Measuring Abrasion Using the Dry Sand/Rubber Wheel.

In another aspect, composite sheets for providing alloy matrix composite coatings to titanium or titanium alloy substrates are described. A composite sheet comprises an organic binder or carrier and powder titanium-based alloy comprising 30-50 wt. % zirconium, 0-30 wt. % copper, 0-30 wt. % nickel, 0-5 wt. % molybdenum and the balance titanium, wherein a combined amount of the copper and nickel ranges from 25-40 wt. % of the titanium-based alloy. The composite sheet, in some embodiments, can also comprise hard particles.

In another aspect, methods of making composite articles are described herein. In some embodiments, a method of making a composite article comprises providing a titanium or titanium alloy substrate, positioning over a surface of the substrate a particulate composition comprising hard particles and metal or alloy powder disposed in a carrier and heating the particulate composition to provide a coating adhered to the titanium or titanium alloy substrate, the coating comprising the hard particles disposed in a metal or alloy matrix, wherein the coating has an adjusted volume loss of less than 20 mm³ determined according to Procedure E of ASTM G65—Standard Test Method for Measuring Abrasion Using the Dry Sand/Rubber Wheel.

In another embodiment, a method of making a composite article comprises providing a titanium or titanium alloy substrate, positioning over a surface of the substrate a particulate composition comprising hard particles disposed in a carrier and positioning over the particulate composition a metal or alloy matrix precursor composition. The particulate composition and the metal or alloy matrix precursor composition are heated to provide a coating adhered to the titanium or titanium alloy substrate, the coating comprising the hard particles disposed in a metal or alloy matrix, wherein the coating has an adjusted volume loss of less than 20 mm³ determined according to Procedure E of ASTM G65—Standard Test Method for Measuring Abrasion Using the Dry Sand/Rubber Wheel. In some embodiments, the carrier of the particulate composition comprises a sheet of polymeric material. The carrier of the particulate composition, in some embodiments, is a liquid.

These and other embodiments are described in greater detail in the detailed description which follows.

### BRIEF DESCRIPTION OF THE DRAWINGS

FIG. 1 is a cross-section metallography of a composite article according to one embodiment described herein.

FIG. 2 illustrates an alloy matrix composite cladded titanium substrate according to one embodiment described herein relative to comparative cladded titanium substrates.

FIG. 3 provides cross-section metallographs of a composite article according to one embodiment described herein.

FIG. 4 provides cross-section metallographs of a composite article according to one embodiment described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Composite Articles

In one aspect, composite articles are described herein comprising a lightweight, high strength metal substrate and a wear resistant coating adhered to the substrate. In some embodiments, a composite article comprises a titanium or titanium alloy substrate and a coating adhered to the substrate, the coating comprising particles disposed in a metal or alloy matrix, wherein the coating has an adjusted volume loss of less than 20 mm³ determined according to Procedure E of ASTM G65—Standard Test Method for Measuring Abrasion Using the Dry Sand/Rubber Wheel.

Turning now to components of articles, a composite article described herein comprises a titanium or titanium alloy substrate. In some embodiments, a titanium or titanium alloy substrate has a hexagonal close-packed (hcp) α-phase crystalline structure. In some embodiments, titanium of the substrate is alloyed with one or more a stabilizers comprising elements selected from Groups IIIA-VIA of the Periodic Table. Groups of the Periodic Table described herein are identified according to the CAS designation. In some embodiments, for example, titanium is alloyed with one or more of aluminum, nitrogen, oxygen, carbon, gallium or germanium.

Alternatively, in some embodiments, a titanium or titanium alloy substrate has a body-centered cubic (bcc) β-phase crystalline structure. In some embodiments, titanium of the substrate is alloyed with one or more β stabilizers comprising elements selected from Groups IVA, IB and IVB-VIIIB of the Periodic Table. In some embodiments, for example, titanium of the substrate is alloyed with one or more of molybdenum, vanadium, tantalum, niobium manganese, iron, chromium, cobalt, nickel, copper or silicon.

Further, a titanium alloy substrate, in some embodiments, is an α/β alloy. In some embodiments, titanium is alloyed with one or more a stabilizers and one or more β stabilizers. In one embodiment, for example, an α/β titanium alloy substrate is Ti6Al4V.

Titanium or titanium alloy substrates of composite articles described herein can demonstrate various geometries. In some embodiments, a substrate has a curved, circular or cylindrical geometry. A substrate, in some embodiments, has a polygonal or planar geometry. In some embodiments, a substrate has a geometry suitable for one or more critical wear applications. In some embodiments, for example, titanium or titanium alloy substrates of composite articles described herein comprise flow control components including, but not limited to, valves, impellers, blades, gears, bearings, nozzles, wear components and/or seals.

A composite article described herein comprises a coating adhered to the substrate, the coating comprising particles disposed in a metal or alloy matrix. The metal or alloy matrix of the coating can be selected according to various considerations including, but not limited to, the compositional identity of the substrate and/or the compositional identity of the particles to be disposed in the metal or alloy matrix. In some embodiments, for example, the metal or alloy matrix has a melting point or solidus temperature below the β-transus of the titanium or titanium alloy substrate. Moreover, in some embodiments, the metal or alloy matrix does not solubilize, partially solubilize and/or form interfacial reaction product with the particles disposed in the metal or alloy matrix. In some embodiments, for example, interfacial reaction product is not evident between the metal or alloy matrix and particles disposed in the matrix by optical microscopy at a magnification of 100×.

In some embodiments, the metal or alloy matrix of the coating comprises a brazing metal or brazing alloy. Any brazing metal or alloy not inconsistent with the objectives of the present invention can be used as the matrix of the coating. In some embodiments, for example, an alloy matrix of the coating is a titanium-based alloy having compositional parameters derived from Table I.

TABLE I
Coating Ti-Based Alloy Matrix Compositional Parameters

| Element | Amount (wt %) |
|---|---|
| Zirconium | 0-50 |
| Copper | 0-30 |
| Nickel | 0-30 |
| Molybdenum | 0-5 |
| Titanium | Balance |

In some embodiments, the alloy matrix of the coating is selected from the titanium-based alloys of Table II.

TABLE II
Coating Ti-Based Alloy Matrix Compositional Parameters

| Ti-Based | |
|---|---|
| Alloy | Compositional Parameters (wt. %) |
| 1 | Ti—(0-50)% Zr—(0-30)% Cu—(0-30%)Ni—(0-5)% Mo |
| 2 | Ti—(30-50)% Zr—(0-25)% Cu—(0-25%)Ni—(0-5)% Mo |
| 3 | Ti—(35-45)% Zr—(18-25)% Cu—(5-25%)Ni—(0-5)% Mo |
| 4 | Ti—(35-45)% Zr—(12-25)% Cu—(5-25%)Ni—(0-5)% Mo |
| 5 | Ti—(36-39)% Zr—(12-25)% Cu—(5-25%)Ni—(0-5)% Mo |
| 6 | Ti—(36-39)% Zr—(12-18)% Cu—(5-15%)Ni—(0-5)% Mo |
| 7 | Ti—(36-39)% Zr—(12-18)% Cu—(8-12%)Ni—(0-5)% Mo |
| 8 | Ti—(36-39)% Zr—(14-16)% Cu—(9-11%)Ni—(0-5)% Mo |
| 9 | Ti—37.5% Zr—15% Cu—10% Ni |
| 10 | Ti—37.5% Zr—15% Cu—10% Ni—1% Mo |
| 11 | Ti—24% Zr—16% Cu—16% Ni—0.5% Mo |
| 12 | Ti—26% Zr—14% Cu—14% Ni—0.5% Mo |
| 13 | Ti—(18-22)% Zr—(18-22)% Cu—(18-22)Ni |
| 14 | Ti—(18-22)% Zr—(18-22)% Cu—(18-22)% Ni—1% Mo |
| 15 | Ti—15% Cu—25% Ni |
| 16 | Ti—15% Cu—15% Ni |

Titanium-based alloys forming matrices of coatings described herein, in some embodiments, demonstrate a combined amount of copper and nickel ranging from 25-40 wt. %. For example, any of the titanium-based alloy compositions listed in Tables I-II can comprise a combined amount of copper and nickel ranging from 25-40 wt. %. In one embodiment, a titanium-based alloy matrix comprises 35-45 wt. % zirconium, 0-30 wt. % copper, 0-30 wt. % nickel, 0.5 wt. % molybdenum and the balance titanium, wherein the combined amount of copper and nickel in the titanium-based alloy ranges from 25-40 wt. %

A combined amount of copper and nickel is determined by summing the wt. % of copper and the wt. % of nickel in the titanium-based alloy. Further, in embodiments wherein nickel is not present in the titanium-based alloy, the combined amount of copper and nickel equals the amount of copper in the alloy. Similarly, in embodiments wherein copper is not present in the titanium-based alloy, the combined amount of copper and nickel equals the amount of nickel in the alloy.

Suitable titanium-based alloy brazes are commercially available from Titanium Brazing, Inc. or Cleveland, Ohio.

As described herein, the coating adhered to the substrate comprises particles disposed in the metal or alloy matrix. Particles suitable for use in the coating can be selected according to several considerations including, but not limited to, the desired wear resistance, abrasion resistance, erosion resistance or hardness of the coating and/or the compositional identity of the metal or alloy matrix. In some embodiments, suitable particles are insolvent or substantially insolvent in the metal or alloy matrix and have desirable wetting characteristics inhibiting or precluding particle agglomeration. Additionally, in some embodiments, particles of the coating do not demonstrate interfacial reaction product with the metal or alloy matrix. In one embodiment, for example, interfacial reaction product is not evident between the particles and metal or alloy matrix by optical microscopy at a magnification of 100×.

Particles suitable for use in the metal or alloy matrix of the coating can comprise hard particles. Hard particles of the coating, in some embodiments, comprise particles of metal carbides, metal nitrides, metal carbonitrides, metal oxides, metal borides, metal silicides, cemented carbides, cast carbides or other ceramics or mixtures thereof. In some embodiments, metallic elements of hard particles of the coating comprise aluminum, boron and/or one or more metallic elements selected from Groups IVB, VB and/or VIB of the Periodic Table. Hard particles, in some embodiments, comprise nitrides or carbonitrides of aluminum, boron, silicon, titanium, zirconium, hafnium, tantalum or niobium or mixtures thereof. In some embodiments, hard particles comprise carbides of titanium, tungsten, silicon, boron or mixtures thereof. Additionally, in some embodiments, hard particles comprise borides such as titanium di-boride and tantalum borides, silicides such as MoSi₂ or alumina. Hard particles, in some embodiments, comprise crushed cemented carbide, crushed carbide, crushed nitride, crushed boride or crushed silicide or combinations thereof. In some embodiments, hard particles comprise intermetallic compounds such as nickel aluminide.

Hard particles of the coating can have any size not inconsistent with the objectives of the present invention. In some embodiments, hard particles of the coating have a size distribution ranging from about 0.1 μm to about 1 mm. Hard particles, in some embodiments, have a size distribution ranging from about 1 μm to about 500 μm. In some embodiments, hard particles have a size distribution ranging from about 10 μm to about 300 μm or from about 30 μm to about 150 μm. In some embodiments, hard particles have a size distribution ranging from 10 μm to 100 μm. Hard particles can also demonstrate bimodal or multi-modal size distributions.

Hard particles of the coating can have any desired shape or geometry. In some embodiments, hard particles have spherical or elliptical geometry. In some embodiments, hard particles have a polygonal geometry. In some embodiments, hard particles have irregular shapes, including shapes with sharp edges.

Hard particles can be present in the metal or alloy matrix of the coating in any amount not inconsistent with the objectives of the present invention. Hard particle loading can be varied according to several considerations including, but not limited to, the desired hardness, wear resistance and/or toughness of the coating. In some embodiments, hard particles are present in the metal or alloy matrix in an amount ranging from about 20 volume percent to about 90 volume percent. Hard particles, in some embodiments, are present in an amount ranging from about 30 volume percent to about 85 volume percent. In some embodiments, hard particles are present in an amount ranging from about 40 volume percent to about 70 volume percent. Further, in some embodiments, hard particles are uniformly or substantially uniformly distributed in the metal or alloy matrix.

The coating of a composite article described herein can have any thickness not inconsistent with the objectives of the present invention. In some embodiments, coating thickness is selected according to several considerations, such as the desired wear/abrasion characteristics and/or lifetime of the coating. In some embodiments, the coating has a thickness of at least about 100 μm or at least about 500 μm. The coating, in some embodiments, has a thickness of at least about 750 μm or at least about 1 mm. In some embodiments, the coating has a thickness ranging from about 100 μm to about 5 mm. In some embodiments, the coating has a thickness ranging from about 200 μm to about 2 mm or from about 500 μM to about 1 mm.

The coating, in some embodiments, is fully dense or substantially fully dense. Alternatively, in some embodiments, the coating has porosity. Porosity of the coating, in some embodiments, is less than about 15% by volume. In some embodiments, porosity of the coating is less than about 10% by volume or less than about 5% by volume. In some embodiments, porosity of the coating ranges from about 1% by volume to about 10% by volume. Porosity of the coating, in some embodiments, ranges from about 1% by volume to 5% by volume. In some embodiments, porosity of the coating is uniform or substantially uniform.

The coating of a composite article described herein, in some embodiments, is metallurgically bonded to the titanium or titanium alloy substrate. In some embodiments, a composite article comprises an interfacial transition region between the titanium or titanium alloy substrate and the coating. The interfacial transition region, in some embodiments, has a microstructure or crystalline structure different from the substrate and the coating. Additionally, in some embodiments, the interfacial transition region has a thickness ranging from about 50 μm to about 300 μm or from about 75 μm to about 250 μm.

As described herein, the coating of a composite article, in some embodiments, displays an adjusted volume loss of less than 20 mm³. Values of adjusted volume loss for coatings described herein are determined according to Procedure E of ASTM G65—Standard Test Method for Measuring Abrasion Using the Dry Sand/Rubber Wheel. In some embodiments, the coating demonstrates an adjusted volume loss of less than 15 mm³ or less than 12 mm³. In some embodiments, the coating has an adjusted volume loss of less than 10 mm³ or less than 6 mm³. The coating, in some embodiments, has an adjusted volume loss ranging from about 0.5 mm³ to about 20 mm³ or from about 0.5 mm³ to about 12 mm³. In some embodiments, the coating has an adjusted volume loss ranging from about 0.5 mm³ to about 6 mm³. It is contemplated that various hard particle and metal or alloy matrix combinations will produce coatings having differing adjusted volume loss values.

In view of the disclosure herein, it is within the purview of one of skill in the art to select hard particle and metal or alloy matrix combinations producing coatings having an adjusted volume loss consistent with one or more of the values recited herein. In some cases, for example, hard particle/matrix alloy combinations demonstrating interfacial reaction product and/or hard particle solubilization by the matrix provide compromised coatings having values of adjusted volume loss inconsistent with the same recited herein.

Various coating embodiments comprising hard particles described herein in combination with metal or alloy matrices described herein having an adjusted volume loss consistent with one or more of the values recited herein are contemplated. In some embodiments, for example, a coating described herein comprises a hard particle and alloy matrix combination of titanium carbide particles and/or tungsten carbide particles and an titanium-based alloy of Ti-(18-22) % Zr-(18-22) % Cu-(18-22) % Ni. A coating described herein, in some embodiments, comprises a hard particle and alloy matrix combination of titanium carbide particles and a titanium-based alloy of Ti-37.5% Zr-15% Cu-10% Ni. Further, a coating described herein can comprise a hard particle and alloy matrix combination of titanium carbide particles and a titanium-based alloy of Ti-(35-45) % Zr-(12-25) % Cu-(5-25%)Ni-(0-5) % Mo or a titanium-based alloy of Ti-(36-39) % Zr-(12-18) % Cu-(8-12) % Ni-(0-5) % Mo.

In some embodiments, a composite article described herein further comprises one or more layers of refractory material deposited by CVD, PVD or combinations thereof over the coating of hard particles disposed in the metal or alloy matrix. CVD and/or PVD layer(s) deposited over the coating, in some embodiments, comprise ceramics, diamond, diamond-like carbon, tungsten carbide or combinations thereof. In some embodiments, CVD and/or PVD layer(s) deposited over the coating comprise aluminum and/or one or more metallic elements selected from Groups IVB, VB and/or VIB of the Periodic Table and one or more non-metallic elements selected from Groups IIIA, IVA, VA and/or VIA of the Periodic Table. In some embodiments, the refractory layer(s) are deposited over the coating by low temperature or medium temperature CVD.

### II. Composite Sheets

In another aspect, composite sheets for providing alloy matrix composite claddings to titanium or titanium alloy substrates are described. A composite sheet comprises an organic binder or carrier and titanium-based alloy powder comprising 30-50 wt. % zirconium, 0-30 wt. % copper, 0-30 wt. % nickel, 0-5 wt. % molybdenum and the balance titanium, wherein a combined amount of the copper and nickel ranges from 25-40 wt. % of the titanium-based alloy.

Turning now to specific components, a composite sheet comprises an organic binder or carrier. Organic binder of the composite sheet can comprise one or more polymeric materials. Suitable polymeric materials for use in the sheet can comprise one or more fluoropolymers including, but not limited to, polytetrafluoroethylene (PTFE). In comprising an organic binder, composite sheets described herein can be cloth-like and/or flexible in nature.

Titanium-based powder alloy is combined with the organic binder in constructing the composite sheet. The organic binder and the powder alloy are mechanically worked or processed to trap the alloy powder in the organic binder. In one embodiment, for example, titanium-based powder alloy is mixed with 3-15 vol. % PTFE and mechanically worked to fibrillate the PTFE and trap the powder alloy. Mechanical working can include rolling, ball milling, stretching, elongating, spreading or combinations thereof. In some embodiments, the sheet comprising the powder alloy is subjected to cold isostatic pressing. The resulting composite sheet can have a low elastic modulus and high green strength. In some embodiments, a sheet comprising organic binder and powder alloy is produced in accordance with the disclosure of one or more of U.S. Pat. Nos. 3,743,556, 3,864,124, 3,916,506, 4,194,040 and 5,352,526, each of which is incorporated herein by reference in its entirety.

Suitable powder titanium-based alloy can comprise at least 30 wt. % zirconium in addition to other alloying elements including copper and nickel. Titanium-based alloy powder for combination with the organic binder can have a composition selected from Table III.

TABLE III
Titanium-based alloy of composite sheet

| Ti-Based | |
|---|---|
| Alloy | Compositional Parameters (wt. %) |
| 1 | Ti—(30-50)% Zr—(0-30)% Cu—(0-30%)Ni—(0-5)% Mo |
| 2 | Ti—(30-50)% Zr—(0-25)% Cu—(0-25%)Ni—(0-5)% Mo |
| 3 | Ti—(35-45)% Zr—(18-25)% Cu—(5-25%)Ni—(0-5)% Mo |
| 4 | Ti—(35-45)% Zr—(12-25)% Cu—(5-25%)Ni—(0-5)% Mo |
| 5 | Ti—(36-39)% Zr—(12-25)% Cu—(5-25%)Ni—(0-5)% Mo |
| 6 | Ti—(36-39)% Zr—(12-18)% Cu—(5-15%)Ni—(0-5)% Mo |
| 7 | Ti—(36-39)% Zr—(12-16)% Cu—(8-12%)Ni—(0-5)% Mo |
| 8 | Ti—(36-39)% Zr—(14-16)% Cu—(9-11%)Ni—(0-5)% Mo |
| 9 | Ti—37.5% Zr—15% Cu—10% Ni |
| 10 | Ti—37.5% Zr—15% Cu—10% Ni—1% Mo |

As described herein, powder titanium-based alloy for combination with the organic binder can have a combined amount of copper and nickel ranging from 25-40 wt. % of the alloy. Any of the titanium-based alloy compositions of Table III, for example, can demonstrate a combined amount of copper and nickel ranging from 25-40 wt. % of the alloy.

Further, a composite sheet described herein can also comprise hard particles in combination with the organic binder and powder titanium-based alloy. Hard particles of the composite sheet can comprise any of the hard particles described in Section I hereinabove. Hard particles, for example, can comprise particles of metal carbides, metal nitrides, metal carbonitrides, metal oxides, metal borides, metal silicides, cemented carbides, cast carbides or other ceramics or mixtures thereof. In some embodiments, metallic elements of hard particles comprise aluminum, boron and/or one or more metallic elements selected from Groups IVB, VB and/or VIB of the Periodic Table. In one embodiment, hard particles comprise titanium carbide.

Hard particles can be present in the composite sheet in any amount not inconsistent with the objectives of the present invention. Hard particles, in some embodiments, are present in an amount sufficient to provide the resulting coating or cladding the desired hard particle loading. Hard particles, for example, can be present in the composite sheet in an amount sufficient to provide the coating or cladding metallurgically bound to the titanium substrate a hard particle content of 20-90 vol. % or 40-70 vol. %.

As described further herein, the composite sheet can be applied over a surface of the titanium substrate and heated. Heating decomposes the organic binder of the sheet and at least partially melts the titanium-based alloy powder for infiltrating spacing between the hard particles resulting in an alloy matrix composite metallurgially bound to the titanium substrate. An alloy matrix composite coating or cladding formed with a composite sheet can have any of the properties recited in Section I for a coating or cladding, including being fully dense or substantially fully dense and having an adjusted volume less of less than 20 mm³.

### III. Methods of Making Composite Articles

In another aspect, methods of making composite articles are described herein. In some embodiments, a method of making a composite article comprises providing a titanium or titanium alloy substrate, positioning over a surface of the substrate a particulate composition comprising hard particles and metal or alloy powder disposed in a carrier and heating the particulate composition to provide a coating adhered to the titanium or titanium alloy substrate, the coating comprising the hard particles disposed in a metal or alloy matrix, wherein the coating has an adjusted volume loss less than 20 mm³

Turning now to method steps, a method described herein comprises providing a titanium or titanium alloy substrate. In some embodiments, a suitable titanium or titanium alloy substrate comprises any of the titanium or titanium alloy substrates described in section I hereinabove. In some embodiments, for example, a titanium alloy substrate is Ti6Al4V.

After selection of the titanium or titanium alloy substrate, a particulate composition comprising hard particles and metal or alloy powder disposed in a carrier is positioned over the substrate. In some embodiments, hard particles disposed in the carrier can comprise any of the hard particles described in section I hereinabove. Similarly, in some embodiments, metal or alloy powder disposed in the carrier can comprise any metal or alloy described in Sections I and II hereinabove, including the alloys provided in Tables I, II and III.

The carrier of the particulate composition can comprise an organic binder, such as a polymeric material. In such embodiments, the metal or alloy powder can be provided as a composite sheet as described in Section II. Hard particles and metal or alloy powder, in some embodiments, are combined with a polymeric material in amounts reflecting the desired compositional percentages of the hard particles and metal or alloy in the finished coating. In some embodiments, for example, hard particles and metal or alloy powder are combined with a polymeric material in amounts consistent with any of the compositional percentages of the hard particles and metal or alloy in the coating recited in section I hereinabove.

Alternatively, the particulate composition comprising hard particles and a metal or alloy powder is combined with a liquid carrier for application to the substrate. In some embodiments, for example, the particulate composition is disposed in a liquid carrier to provide a slurry or paint for application to the substrate. Suitable liquid carriers for particulate compositions described herein comprise several components including dispersion agents, thickening agents, adhesion agents, surface tension reduction agents and/or foam reduction agents. In some embodiments, suitable liquid carriers are aqueous based.

Particulate compositions disposed in a liquid carrier can be applied to surfaces of the substrate by several techniques including, but not limited to, spraying, brushing, flow coating, dipping and/or related techniques. The particulate composition can be applied to the substrate surface in a single application or multiple applications depending on desired thickness of the coating. Moreover, in some embodiments, particulate compositions disposed in liquid carriers can be prepared and applied to substrate surfaces in accordance with the disclosure of U.S. Pat. No. 6,649,682 which is hereby incorporated by reference in its entirety.

After being disposed over a surface of the substrate, the sheet or liquid carrier comprising the particulate composition is heated to provide the coating adhered to the substrate, the coating comprising the hard particles disposed in a metal or alloy matrix formed by melting the metal or alloy powder composition. The sheet or liquid carrier is decomposed or burned off during the heating process. In some embodiments, the substrate and sheet or liquid carrier comprising the particulate composition are heated in a vacuum, inert or reducing atmosphere at a temperature and for a time period where the integrity of the substrate is maintained and the powder metal or powder alloy is densified to the desired amount. In some embodiments, for example, the substrate and sheet or liquid carrier comprising the particulate composition are heated to a temperature below the β transus of the titanium or titanium alloy substrate but above the liquidus temperature of the metal or alloy powder.

Further, as known to one of skill in the art, heating conditions including temperatures, atmosphere and time are dependent on several considerations including the identity of the substrate, the identity of the powder metal or powder alloy and the desired structure of the resulting coating.

In some embodiments, the particulate composition comprising the hard particles and metal or alloy powder is heated under conditions sufficient to produce a fully dense or substantially fully dense coating. Alternatively, the particulate composition, in some embodiments, is heated under conditions to produce a coating having porosity. In some embodiments, for example, the particulate composition is heated under conditions to produce a coating having porosity recited in section I hereinabove. In some embodiments, the particulate composition is subjected to hot isostatic pressing and/or other mechanical processing to achieve the desired densification. In some embodiments, however, a fully dense or substantially fully dense coating can be provided without subjecting the particulate composition to hot isostatic pressing and/or other mechanical processing.

In some embodiments, heating the substrate and particulate composition metallurgically binds the resulting coating to the substrate. In some embodiments, an interfacial transition region is established between the coating and the titanium or titanium alloy substrate. The interfacial transition region can have any property recited in section I hereinabove for the interfacial transition region.

Additionally, in some embodiments, the substrate is cleaned prior to application of the sheet or liquid carrier comprising the particulate composition. Cleaning the substrate can be administered by chemical treatment, mechanical treatment or both. In some embodiments, for example, a substrate is subjected to grit or particle blasting.

In another embodiment, a method of making a composite article described herein comprises providing a titanium or titanium alloy substrate, positioning over a surface of the substrate a particulate composition comprising hard particles disposed in a carrier and positioning over the particulate composition a metal or alloy matrix precursor composition. The particulate composition and the metal or alloy matrix precursor composition are heated to provide a coating adhered to the titanium or titanium alloy substrate, the coating comprising the hard particles disposed in a metal or alloy matrix.

A titanium or titanium alloy substrate can comprise any of the titanium or titanium alloy substrates described in section I hereinabove. Moreover, hard particles disposed in a carrier can comprise any of the hard particles described in section I hereinabove. As described in this Section III, a carrier of the hard particles, in some embodiments, comprises an organic binder such as a polymeric material. Hard particles and a polymeric binder can be combined and formed into a sheet as described in Section II herein. Alternatively, a carrier of the hard particles, is a liquid as described in this Section III.

A metal or alloy matrix precursor composition is positioned over the particulate composition of the hard particles disposed in the carrier. In some embodiments, a metal or alloy matrix precursor composition comprises a metal or alloy foil or sheet. For example, in some embodiments, a foil or thin sheet of the desired metal or alloy composition is positioned over the particulate composition. In some embodiments, an alloy foil or sheet is any alloy described in section I hereinabove, including the alloys provided in Tables I, II and III.

Alternatively, a metal or alloy matrix precursor composition comprises a metal or alloy powder disposed in a carrier. In some embodiments, a carrier for the metal or alloy powder comprises an organic binder, such as a polymeric material. Metal or alloy powder and a polymeric binder, for example, can be combined and formed into a composite sheet as described in Section II. A carrier for the metal or alloy powder, in some embodiments, is a liquid.

The titanium or titanium alloy substrate, particulate composition and metal or alloy matrix precursor composition are heated to provide a coating adhered to the substrate, the coating comprising the hard particles disposed in a metal or alloy matrix formed by melting of the metal or alloy matrix precursor composition. Organic and/or liquid components of the particulate composition and/or matrix precursor composition are decomposed or burned off in the heating process. In some embodiments, the heating process is conducted in a vacuum, inert or reducing atmosphere at a temperature and for a time period wherein the integrity of the substrate is maintained and the metal or alloy matrix precursor composition is densified to the desired amount. For example, in some embodiments, the titanium or titanium alloy substrate, particulate composition and metal or alloy matrix precursor composition are heated to a temperature below the β transus of the substrate but above the liquidus temperature of the metal or alloy matrix precursor composition.

In some embodiments, the particulate composition and the matrix precursor composition are heated under conditions sufficient to produce a fully dense or substantially fully dense coating. Alternatively, the particulate composition and the matrix precursor composition, in some embodiments, are heated under conditions to produce a coating having porosity. In some embodiments, for example, the particulate composition and the matrix precursor composition are heated under conditions to produce a coating having porosity recited in section I hereinabove. In some embodiments, the particulate composition and matrix precursor composition are subjected to hot isostatic pressing and/or other mechanical processing to achieve the desired densification. In some embodiments, however, a fully dense or substantially fully dense coating can be provided without subjecting the particulate composition and the metal or alloy matrix precursor composition to hot isostatic pressing and/or other mechanical processing.

In some embodiments, heating the substrate, particulate composition and matrix precursor composition metallurgically binds the resulting coating to the substrate. In some embodiments, an interfacial transition region is established between the coating and the titanium or titanium alloy substrate. The interfacial transition region can have any property recited in section I hereinabove for the interfacial transition region.

Coatings produced according to methods described herein, in some embodiments, have an adjusted volume loss of less than 20 mm³ determined according to Procedure E of ASTM G65—Standard Test Method for Measuring Abrasion Using the Dry Sand/Rubber Wheel. In some embodiments, a coating produced according to a method described herein has any adjusted volume loss value recited for a coating in section I hereinabove.

Additionally, in some embodiments, hard particles of a coating produced according to a method described herein are uniformly or substantially uniformly distributed in the metal or alloy matrix. In some embodiments, the hard particles are insolvent or substantially insolvent in the metal or alloy matrix. Further, in some embodiments, interfacial reaction product is not evident between the hard particles and the metal or alloy matrix by optical microscopy at a magnification of 100×.

In some embodiments, methods described herein further comprise depositing one or more layers of refractory material over the coating of hard particles disposed in the metal or alloy matrix. The one or more layers of refractory material, in some embodiments, are deposited by CVD, PVD or combinations thereof. In some embodiments, the one or more refractory layers comprise ceramics, diamond, diamond-like carbon, tungsten carbide or combinations thereof. In some embodiments, the CVD and/or PVD layer(s) deposited over the coating comprise aluminum and/or one or more metallic elements selected from Groups IVB, VB and/or VIB of the Periodic Table and one or more non-metallic elements selected from Groups IIIA, IVA, VA and/or VIA of the Periodic Table. In some embodiments, the refractory layer(s) are deposited over the coating by low temperature or medium temperature CVD.

These and other embodiments are further illustrated by the following non-limiting examples.

### Example 1

### Composite Article

A composite article having a construction described herein was produced as follows. Titanium carbide powder (−325 mesh) was mixed with 10% by volume PTFE. The mixture was mechanically worked to fibrillate PTFE and trap the titanium carbide particles and then rolled, thus making a cloth-like flexible abrasive carbide sheet as described in U.S. Pat. No. 4,194,040. A powdered foil which was 200 to 300 microns in thickness with composition 18-22% zirconium, 18-22% copper, 18-22% nickel by weight with the balance titanium was used as the braze material.

The titanium carbide sheet was applied to the surface of a Ti6Al4V substrate by means of adhesive and the powdered braze foil was glued in place over the titanium carbide sheet. The sample was heated in a vacuum furnace to 940-980° C. at a rate of 5-10° C./min for approximately 15 minutes to 60 minutes, during which the braze foil melted and infiltrated the titanium carbide sheet. Upon cooling, a composite coating/cladding was formed comprising a titanium carbide abrasive resistant layer metallurgically bonded to the Ti6Al4V substrate.

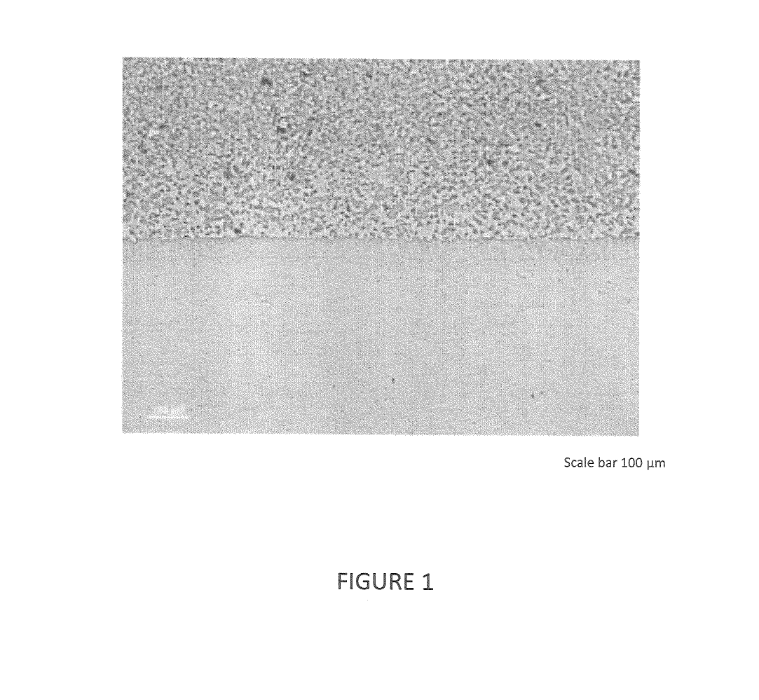

The coating/cladding of the resulting composite article was uniformly bonded to the substrate without significant visual defects (cracks, pores, wrinkles). Metallographic examination of the cross-section at 100× of the coating/cladding of the present example, as illustrated in FIG. 1, indicated the absence of significant defects at the interface between the coating/cladding and substrate. Moreover, the coating demonstrated an adjusted volume loss of 4 mm³ according to Procedure E of ASTM G65—Standard Test Method for Measuring Abrasion Using the Dry Sand/Rubber Wheel.

### Example 2

### Composite Sheet

A composite sheet described herein was produced as follows. A titanium-based brazing powder (−200 mesh) having the composition of Ti-(36-39)wt. % Zr-(14-16)wt. % Cu-(9-11)wt. % Ni was combined with 4.8% by volume PTFE, and mechanically worked to fibrillate the PTFE and trap the titanium-based alloy powder. The alloy powder/PTFE mixture was then rolled, thereby making a cloth-like flexible composite sheet.

### Example 3

### Composite Article

A composite article having a construction described herein was produced as follows. Titanium carbide sheets formed in accordance with Example 1 were applied to surfaces of Ti6Al4V (Composite A) and commercially pure titanium (Composite B) substrates using an adhesive. Composite sheets formed in accordance with Example 2 were subsequently applied over the titanium carbide sheets of Composites A and B. Comparative composites C-F were also fabricated by the same procedure, the differences being the composite sheet of Comparatives C and D employed a titanium-based alloy powder having the composition Ti-25 wt. % Cu-15 wt. % Ni, and the composite sheet of Comparatives E and F employed a titanium-based alloy powder having the composition Ti-20 wt. % Zr-20 wt. % Cu-15-20 wt. % Ni. Table IV summarizes the constructions of Composites A-F prior to heating.

TABLE IV

| | | Hard | |
|---|---|---|---|
| | | Particle | |
| Composite | Substrate | Cloth | Ti-Based Alloy of Composite Sheet |
| A | Ti6Al4V | TiC/PTFE | Ti—(36-39) wt. % Zr—(14-16) wt. |
| | (Grade 5) | | % Cu—(9-11) wt. % Ni |
| B | Ti (pure) | TiC/PTFE | Ti—(36-39) wt. % Zr—(14-16) wt. |
| | | | % Cu—(9-11) wt. % Ni |
| C* | Ti6Al4V | TiC/PTFE | Ti—25 wt. % Cu—15 wt. % Ni |
| | (Grade 5) | | |
| D* | Ti (pure) | TiC/PTFE | Ti—25 wt. % Cu—15 wt. % Ni |
| E* | Ti6Al4V | TiC/PTFE | Ti—20 wt. % Zr—20 wt. |
| | (Grade 5) | | % Cu—15-20 wt. % Ni |
| F* | Ti (pure) | TiC/PTFE | Ti—20 wt. % Zr—20 wt. |
| | | | % Cu—15-20 wt. % Ni |

*Comparative

Composites A and B and Comparative composites C-F were each heated in a vacuum furnace (<10⁻⁵ torr) at a temperature of 920-960° C. and rate of 2-5° C./min and held at temperature for a time period of 55-70 minutes.

Composites A and B demonstrated an alloy matrix composite cladding metallurgically bonded to the Ti6Al4V and Ti substrates. The hard particle layer of TiC particles in each of A and B was fully infiltrated by the titanium-based alloy to provide the alloy matrix composite cladding. Excess alloy matrix on the cladded surface resulting from the cladding operation was removed by grinding to provide a uniformly smooth surface. The alloy matrix composite claddings of Composites A and B each demonstrated an average adjusted volume loss of 3.38 mm³ according to Procedure E of ASTM G65—Standard Test Method for Measuring Abrasion Using the Dry Sand/Rubber Wheel. For reference, non-cladded Ti6Al4V displayed an adjusted volume loss of 147.7 mm³

In contrast to Composites A and B, Comparative composites C-F demonstrated claddings with significant structural problems. Comparative C, for example, displayed insufficient alloy matrix infiltration and considerable spalling while the titanium-based alloy of Comparative D also failed to infiltrate the TiC hard particle layer. Further, changing substrate identity to commercially pure titanium did not improve cladding properties as Comparative composites D and F also demonstrated insufficient infiltration and associated structural problems.

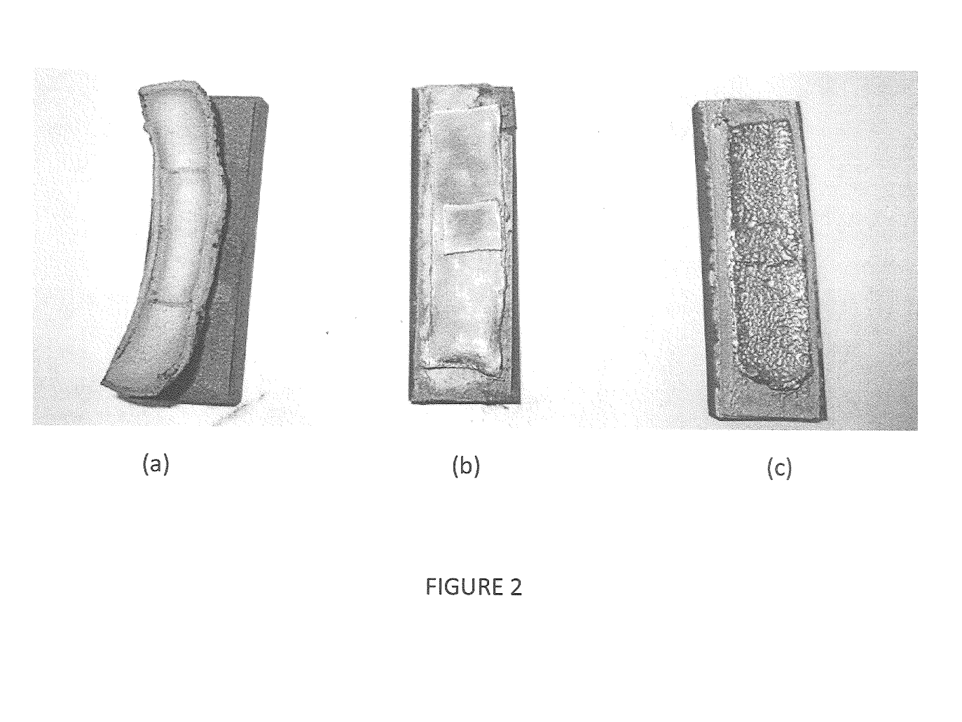

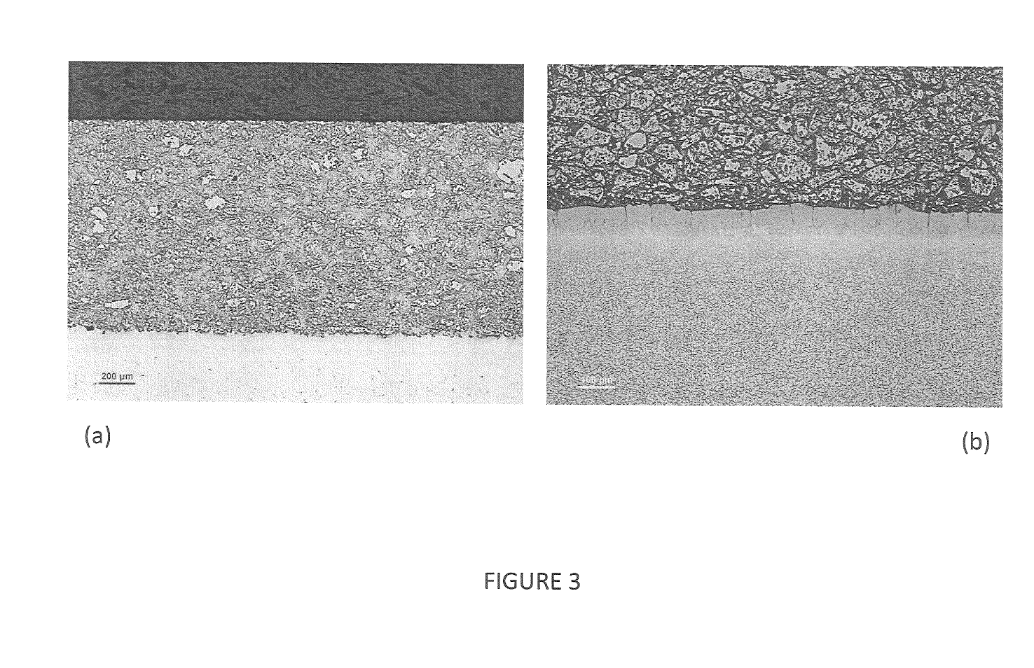

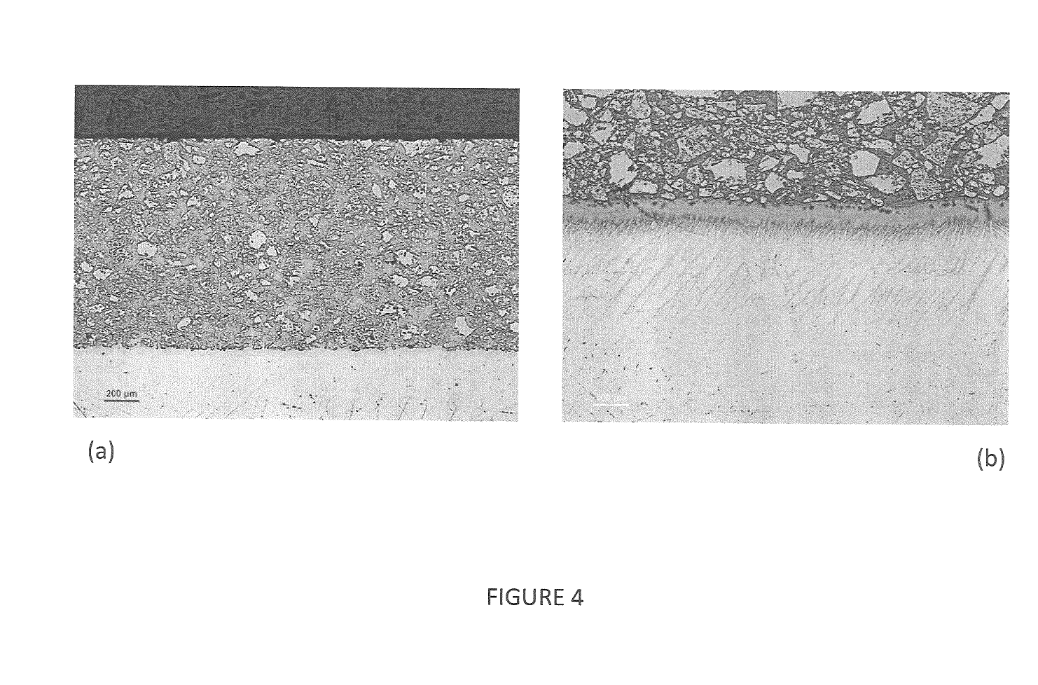

FIG. 2 illustrates Comparative composites C and D relative to Composite A. Significant spalling of Comparative C is shown in FIG. 2(a), and the lack of matrix alloy infiltration of Comparative D is shown in FIG. 2(b). However, Composite A of FIG. 2(c) displays complete infiltration of the TiC hard particle layer by the titanium-based matrix alloy, thereby providing a substantially dense cladding metallurgically bonded to the titanium substrate. Complete infiltration of the TiC hard particle layer by the titanium-based matrix alloy of Composite A is further illustrated in the cross-section metallographs of FIG. 3. FIG. 3(a) demonstrates the substantially uniform nature of the titanium alloy matrix composite cladding metallurgically bonded to the Ti6Al4V substrate. Further, FIG. 3(b) was taken at higher magnification detailing the interfacial transition region established between the titanium alloy matrix composite cladding and Ti6Al4V substrate. FIG. 4 illustrates similar results for Composite B employing the commercially pure titanium substrate. FIG. 4(a) displays the substantially uniform nature of the titanium alloy matrix composite cladding metallurgically bonded to the commercially pure titanium substrate while FIG. 4(b) further characterizes the interfacial transition region established between the titanium alloy matrix composite cladding and commercially pure titanium substrate.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

That which is claimed is:

1. A composite sheet comprising:
an organic binder; and
a powder titanium-based alloy for providing an alloy matrix composite cladding on a titanium or titanium alloy substrate, the powder titanium-based alloy comprising 30-50 wt. % zirconium, 0-30 wt. % copper, 0-30 wt. % nickel, 0-5 wt. % molybdenum and the balance titanium, wherein a combined amount of the copper and nickel ranges from 25-40 wt. % of the titanium-based alloy.

2. The composite sheet of claim 1, wherein the organic binder comprises a polymeric material.

3. The composite sheet of claim 1, wherein the powder titanium-based alloy comprises 35-45 wt. % zirconium, 18-25 wt. % copper, 5-25 wt. % nickel, 0-5 wt. % molybdenum and the balance titanium.

4. The composite sheet of claim 1, wherein the powder titanium-based alloy comprises 35-45 wt. % zirconium, 12-25 wt. % copper, 5-25 wt. % nickel, 0-5 wt. % molybdenum and the balance titanium.

5. The composite sheet of claim 1, wherein the powder titanium-based alloy comprises 36-39 wt. % zirconium, 12-18 wt. % copper, 5-15 wt. % nickel, 0-5 wt. % molybdenum and the balance titanium.

6. The composite sheet of claim 1, wherein the powder titanium-based alloy comprises 36-39 wt. % zirconium, 14-16 wt. % copper, 8-12 wt. % nickel, 0-5 wt. % molybdenum and the balance titanium.

7. The composite sheet of claim 1 further comprising hard particles.

8. The composite sheet of claim 7, wherein the hard particles comprise one or more metal carbides, metal nitrides, metal carbonitrides, metal oxides, metal borides, metal silicides, cemented carbides, cast carbides, boron nitrides or mixtures thereof.

9. The composite sheet of claim 7, wherein the hard particles are present in the sheet in an amount sufficient to provide the alloy matrix composite cladding a hard particle content of 20-90 vol. %.

10. The composite sheet of claim 2, wherein the polymeric material comprises a fluoropolymer.

11. A method of making a composite article comprising:
providing a titanium or titanium alloy substrate;
positioning over a surface of the substrate a particulate composition comprising hard particles disposed in a carrier;
positioning over the particulate composition a composite sheet comprising an organic binder and powder titanium-based alloy comprising 30-50 wt. % zirconium, 0-30 wt. % copper, 0-30 wt. % nickel, 0-5 wt. % molybdenum and the balance titanium, wherein a combined amount of the copper and nickel ranges from 25-40 wt. % of the titanium-based alloy; and
heating the particulate composition and the composite sheet to provide a cladding metallurgiacally bound to the titanium or titanium alloy substrate, the cladding comprising the hard particles disposed in a titanium-based alloy matrix.

12. The method of claim 11, wherein the coating has an adjusted volume loss of less than 20 mm³ determined according to Procedure E of ASTM G65—Standard Test Method for Measuring Abrasion Using the Dry Sand/Rubber Wheel.

13. The method of claim 11, wherein the powder titanium-based alloy comprises 35-45 wt. % zirconium, 18-25 wt. % copper, 5-25 wt. % nickel, 0-5 wt. % molybdenum and the balance titanium.

14. The method of claim 11, wherein the powder titanium-based alloy comprises 35-45 wt. % zirconium, 12-25 wt. % copper, 5-25 wt. % nickel, 0-5 wt. % molybdenum and the balance titanium.

15. The method of claim 11, wherein the powder titanium-based alloy comprises 36-39 wt. % zirconium, 12-18 wt. % copper, 5-15 wt. % nickel, 0-5 wt. % molybdenum and the balance titanium.

16. The method of claim 11, wherein the powder titanium-based alloy comprises 36-39 wt. % zirconium, 14-16 wt. % copper, 8-12 wt. % nickel, 0-5 wt % molybdenum and the balance titanium.

17. A method of making a composite article comprising:
providing a titanium or titanium alloy substrate;
positioning over a surface of the substrate a composite sheet comprising an organic binder, hard particles and powder titanium-based alloy comprising 30-50 wt. % zirconium, 0-30 wt. % copper, 0-30 wt. % nickel, 0-5 wt. % molybdenum and the balance titanium, wherein a combined amount of the copper and nickel ranges from 25-40 wt. % of the titanium-based alloy; and
heating the composite sheet to provide a cladding adhered to the titanium or titanium alloy substrate, the cladding comprising the hard particles disposed in a titanium-based alloy matrix.

18. The method of claim 17, wherein the cladding has an adjusted volume loss of less than 20 mm³ determined according to Procedure E of ASTM G65—Standard Test Method for Measuring Abrasion Using the Dry Sand/Rubber Wheel.

19. The method of claim 17, wherein the powder titanium-based alloy comprises 36-39 wt. % zirconium, 12-18 wt. % copper, 5-15 wt. % nickel, 0-5 wt. % molybdenum and the balance titanium.

20. The method of claim 17, wherein the powder titanium-based alloy comprises 36-39 wt. % zirconium, 14-16 wt. % copper, 8-12 wt. % nickel, 0-5 wt. % molybdenum and the balance titanium.
